(19) United States
(12) Patent Application Publication
(10) Pub. No.: US 2007/0033876 A1
(43) Pub. Date: Feb. 15, 2007

(54) Motion transmission for tailgate

(75) Inventor: Sylvain Chonavel, Thury Harcourt (FR)

Correspondence Address: CARLSON, GASKEY & OLDS, P.C., 400 WEST MAPLE ROAD, SUITE 350, BIRMINGHAM, MI, 48009, US

(73) Assignee: Arvin Technologies, Inc.

(21) Appl. No.: 11/201,784

(22) Filed: Aug. 11, 2005

(51) Int. Cl. E05F 11/24

(52) U.S. Cl. 49/339; 296/56

(57) ABSTRACT

An actuating mechanism for moving a vehicle body panel, such as tailgate, between an open and closed position includes a motor having a drive cable coupled to a rod and cylinder assembly to drive the tailgate between the open and closed positions. A mechanical control including a spring and pulley assembly is coupled to the drive cable to allow acceleration during opening or closing movement of the vehicle panel in response to a user input force.

### TECHNICAL FIELD

The subject invention is directed to a mechanical interface with a tailgate actuator motor that allows a user to accelerate opening or closing of a tailgate as needed.

### BACKGROUND OF THE INVENTION

Vehicles include many different movable panels such as tailgates, doors, hatches, lids, trunks, hoods, etc. that are connected for relative movement to a vehicle body. Motion transmission devices, such as a rod and cylinder assembly, are often used to control movement of a panel, such as a tailgate for example, between an open and closed position.

In some configurations, motors are used as an actuating mechanism for these devices. The motors are activated to open or close the tailgate without requiring a user input force. However, it is often desirable to accelerate opening or closing movement provided by the motor with an additional user input force. Typically, a torque clutch or a torque limiter is coupled to the motor to allow acceleration with the additional user input force.

Torque clutches and torque limiters have several disadvantages. These mechanisms are often noisy, which users find undesirable. Also, inexpensive versions of these mechanisms are difficult to calibrate properly. More expensive versions of these mechanisms are not desirable due to the corresponding increase in cost.

Thus, there is a need for a mechanism that allows a user to accelerate opening or closing movement of a motor driven vehicle panel without requiring a torque clutch or torque limiter.

### SUMMARY OF THE INVENTION

An actuating mechanism includes a mechanical control that cooperates with an actuator motor to allow a user to accelerate opening or closing of a vehicle panel as needed. A rod and cylinder assembly includes a first component coupled to a vehicle body member and a second component coupled to the vehicle panel. The motor includes a drive cable coupled to the rod and cylinder assembly to drive the vehicle panel between the open and closed positions by moving one of the first and second components relative to the other of the first and second components. The mechanical control is coupled to the drive cable to allow acceleration during motor driven opening or closing movement of the vehicle panel in response to an additional user input force.

The mechanical control includes a spring and pulley assembly that is coupled to the drive cable. The spring and pulley assembly includes a first spring mounted between a vehicle body member and a first pulley that guides the drive cable, and a second spring mounted between the vehicle body member and a second pulley that guides the drive cable. The first and second springs resiliently couple the first and second pulleys to the vehicle body member such that the first and second pulleys are movable relative to the vehicle body member.

A third pulley and a fourth pulley are each fixed to the vehicle body member with the third pulley guiding the drive cable into and out of the first pulley and the fourth pulley guiding the drive cable into and out of the second pulley. The first and second pulleys cooperate with the first and second springs for movement relative to the third and fourth pulleys. The first and second pulleys move in various configurations to provide normal opening and closing movement during motor actuation and to provide acceleration during user forced opening or closing movement as needed.

Thus, the subject invention provides an actuating mechanism that allows a user to accelerate opening or closing movement of a motor driven vehicle panel without requiring a torque clutch or torque limiter. These and other features of the present invention can be best understood from the following specification and drawings, the following of which is a brief description.

### BRIEF DESCRIPTION OF THE DRAWINGS

FIG. 1 schematically shows an actuating mechanism incorporating the subject invention for moving a vehicle panel between open and closed positions where the actuating mechanism is shown in an initial configuration.

FIG. 2 schematically shows the actuating mechanism of FIG. 1 in a normal motor driven closing configuration.

FIG. 3 schematically shows the actuating mechanism of FIG. 1 in a user forced closing configuration.

FIG. 4 schematically shows the actuating mechanism of FIG. 1 in a normal motor driven opening configuration.

FIG. 5 schematically shows the actuating mechanism of FIG. 1 in a user forced opening configuration.

### DETAILED DESCRIPTION OF THE PREFERRED EMBODIMENT

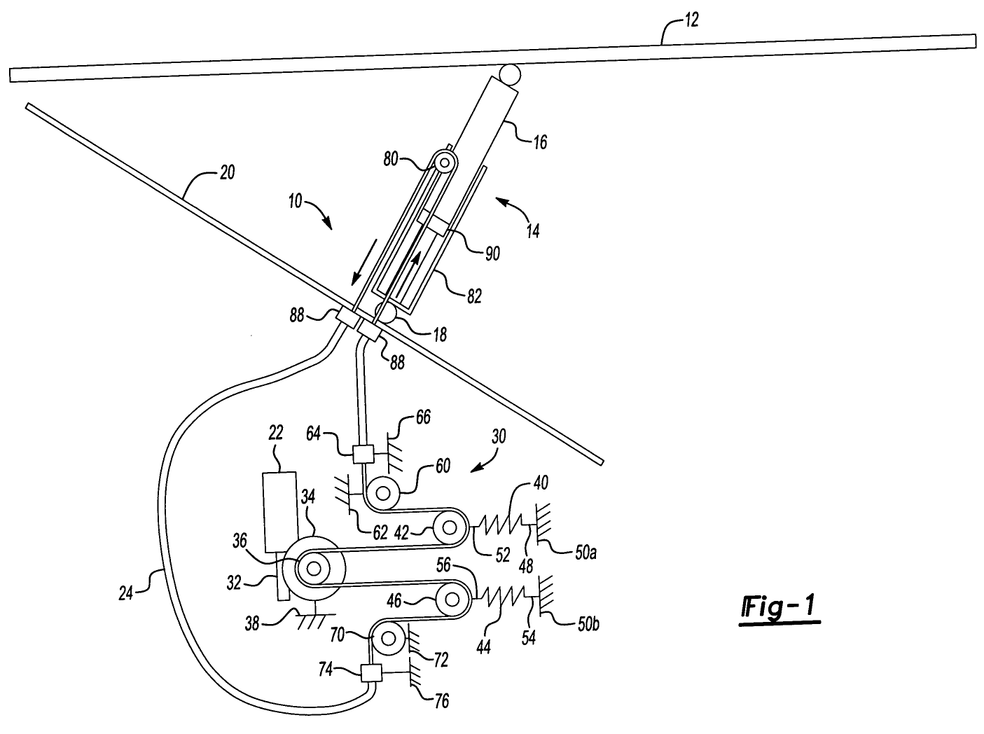

An actuating mechanism 10 for controlling movement of a vehicle panel 12 between an open position and a closed position is shown in FIG. 1. In the example shown, the vehicle panel 12 is a tailgate, however, it should be understood that the actuating mechanism 10 could be used with other vehicle panels, such as doors, hatches, lids, trunks, hoods, etc., for example.

A rod and cylinder assembly 14 includes a first component 16 mounted to the vehicle panel 12 and a second component 18 mounted to a vehicle body member 20. In the example shown, the first component 16 comprises a cylinder and the second component 18 comprises a rod, however, a reverse configuration could also be used. The first 16 and second 18 components move relative to each other as the vehicle panel 12 is moved between the open and closed positions.

A motor 22 is used to drive the vehicle panel 12 between the open and closed positions. The motor 22 includes a cable 24 that is used to drive one of the first 16 and second 18 components for movement relative to the other of the first 16 and second 18 components. A mechanical control, generally shown at 30, cooperates with the motor 22 to allow acceleration during motor driven opening or closing movement of the vehicle panel 12 in response to an additional user input force.

The motor 22 includes an output shaft 32 that drives a drive gear 34 coupled to a drive member 36 that drives the cable 24 back and forth during opening and closing movement. The drive member 36 and drive gear 34 are mounted to a vehicle structure 38. The mechanical control 30 comprises a spring and pulley assembly that is coupled to the cable 24.

The spring and pulley assembly includes a first spring 40 coupled to a first pulley 42 and a second spring 44 coupled to a second pulley 46. The first spring 40 has one spring end 48 fixed to a vehicle body member 50a and an opposite spring end 52 coupled to the first pulley 42. The second spring 44 has one spring end 54 fixed to a vehicle body member 50b and an opposite spring end 56 coupled to the second pulley 46. The first 40 and second 44 springs resiliently coupled the first 42 and second 46 pulleys to vehicle body members 50a, 50b, respectively. The first 42 and second 46 pulleys are thus able to move relative to vehicle body members 50a, 50b during opening and closing movement of the vehicle panel 12. This will be discussed in greater detail below.

A third pulley 60 is used to guide the cable 24 into and out of the first pulley 42. The third pulley 60 is fixed to a vehicle structure 62. A guide 64, held fixed at 66 is used to guide the cable 24 between the third pulley 60 and the rod and cylinder assembly 14. A fourth pulley 70 is used to guide the cable 24 into and out of the second pulley 46. The fourth pulley 70 is fixed to a vehicle structure 72. A guide 74, held fixed at 76, is used to guide the cable 24 between the fourth pulley 70 and the rod and cylinder assembly 14.

A guide 80 is supported on a housing 82, coupled to the second component 18, to guide the cable 24 between the third 60 and fourth 70 pulleys. The motor 22 drives the cable 24 in one direction about guide 80 to move the first 16 and second 18 components relative to each other to open the vehicle panel 12. The motor 22 drives the cable 24 in an opposite direction about guide 80 to move the first 16 and second 18 components relative to each other to close the vehicle panel 12. Additional fixed guide elements 88 guide the cable 24 into and out of guide 80.

A mechanical connection release, shown schematically at 90 in FIG. 1, can be actuated to allowing opening and closing movement of the vehicle panel during an electrical failure condition of the motor 22. Any type of mechanical connection release 90 could be used.

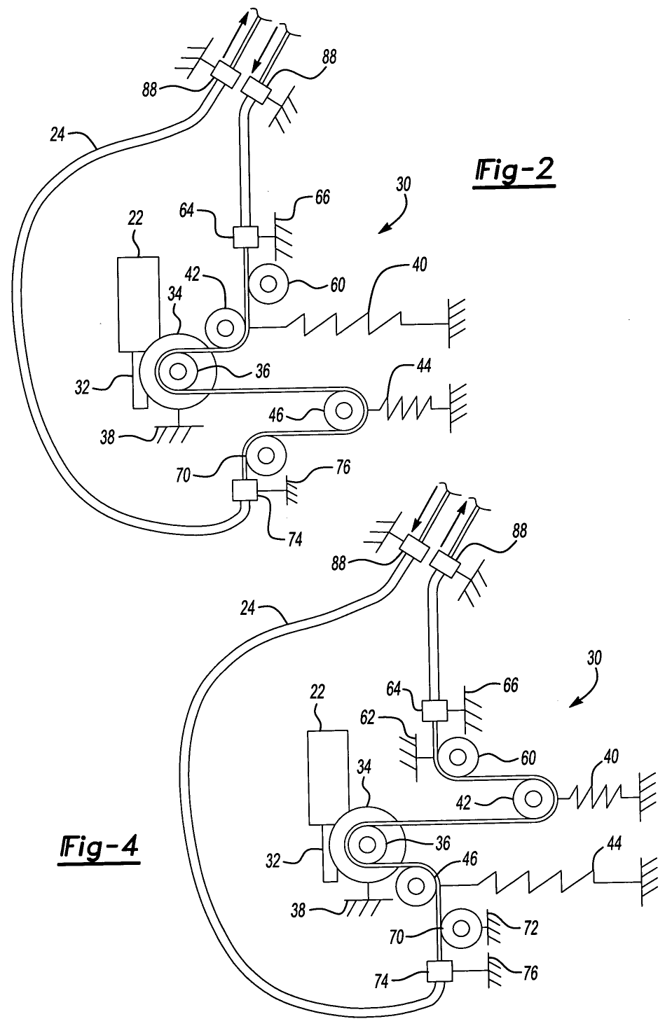

FIG. 2 shows a spring and pulley configuration during normal closing movement of the vehicle panel 12, i.e. motor driven movement of the vehicle panel 12. In this configuration the motor 22 drives the cable 24 such that the first spring 40 is extended to move the first pulley 42 toward the third pulley 60. The second spring 44 and the second pulley 46 remain generally in an initial position as shown in FIG. 1.

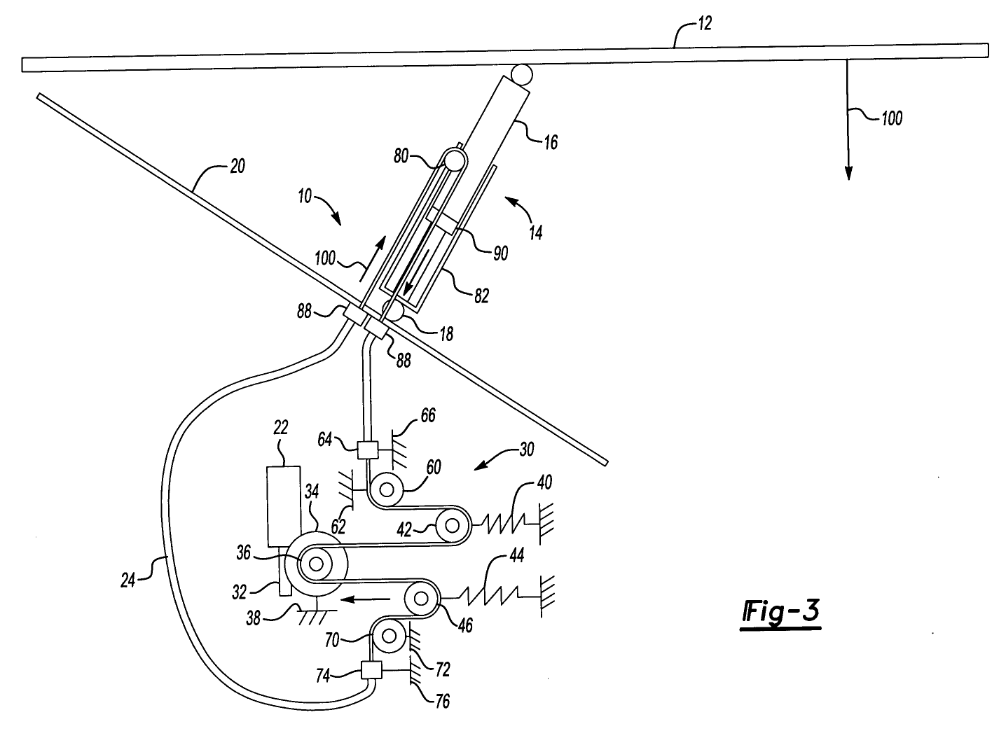

FIG. 3 shows a spring and pulley configuration during a forced closing where a user input force, indicated at 100, is used in addition to driving actuation supplied by the motor 22. In this configuration, as the motor 22 drives the cable 24, a user provides additional input force 100, which causes the second spring 46 to extend and move the second pulley 46 toward the fourth pulley 70. The first spring 40 and first pulley 42, normally moved by the motor 22, remain generally in their initial positions as shown in FIG. 1.

FIG. 4 shows a spring and pulley configuration during normal opening movement of the vehicle panel 12, i.e. motor drive movement of the vehicle panel 12. In this configuration the motor 22 drives the cable 24 such that the second spring 44 is extended to move the second pulley 46 toward the fourth pulley 70. The first spring 40 and the first pulley 42 remain generally in an initial position as shown in FIG. 1.

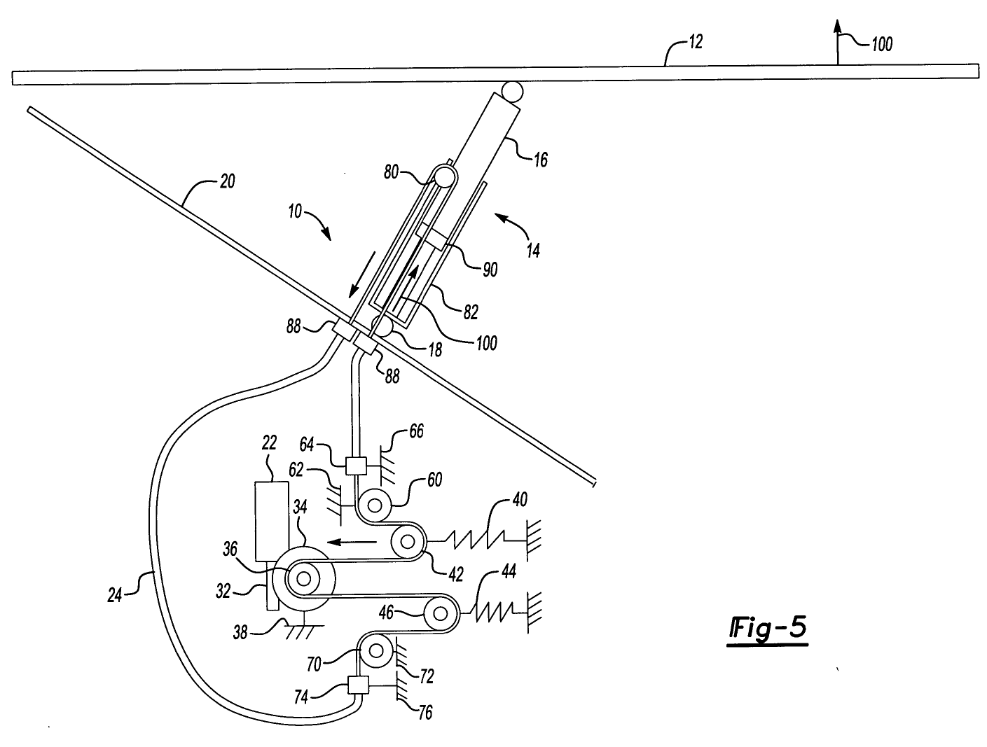

FIG. 5 shows a spring and pulley configuration during a forced opening where a user input force, indicated at 100, is used in addition to driving actuation supplied by the motor 22. In this configuration, as the motor 22 drives the cable 24, a user provides additional input force 100, which causes the first spring 40 to extend and move the first pulley 42 toward the third pulley 60. The second spring 44 and second pulley 46, normally moved by the motor 22, remain generally in their initial positions as shown in FIG. 1.

By coupling independently actuated springs to a motor drive cable, acceleration movement in opposing directions is easily controlled. Thus, the subject invention provides an actuating mechanism that allows a user to accelerate opening or closing movement of a motor driven vehicle panel without requiring a torque clutch or torque limiter.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. An actuating mechanism for moving a vehicle panel between an open and closed position comprising:
a rod and cylinder assembly having a first component adapted for connection to a vehicle body member and a second component adapted for connection to a vehicle panel;
a motor operably coupled to said rod and cylinder assembly to provide relative movement between said first and second components to move the vehicle panel relative to the vehicle body member; and
a mechanical control coupled to said motor to allow acceleration during opening or closing movement of the vehicle panel in response to a user input force.

2. The actuating mechanism according to claim 1 wherein said motor includes a cable that is coupled to one of said first and second components and wherein said mechanical control cooperates with said cable.

3. The actuating mechanism according to claim 1 wherein said mechanical control includes at least a first spring coupled to said cable to allow acceleration during closing movement and a second spring coupled to said cable to allow acceleration during opening movement.

4. The actuating mechanism according to claim 3 wherein said first and second springs are different from each other.

5. The actuating mechanism according to claim 3 wherein each of said first and second springs has one end adapted to be fixed to a vehicle body member and an opposite coupled to a pulley that guides said cable.

6. The actuating mechanism according to claim 3 wherein said first spring has a first spring end adapted to be fixed to a vehicle body member and a second spring end fixed to a first pulley that guides said cable and wherein said second spring has a third spring end adapted to be fixed to the vehicle body member and a fourth spring end fixed to a second pulley that guides said cable, said first and second pulleys being movable relative to the vehicle body member.

7. The actuating mechanism according to claim 1 wherein the vehicle panel comprises a tailgate.

8. An actuating mechanism for moving a vehicle panel between an open and closed position comprising:
a rod and cylinder assembly having a first component adapted for connection to a vehicle body member and a second component adapted for connection to a vehicle panel;
a motor including a drive cable coupled to said rod and cylinder assembly to provide relative movement between said first and second components to move the vehicle panel relative to the vehicle body member between open and closed positions; and
a mechanical control including a spring and pulley assembly that is coupled to said drive cable to allow acceleration during opening or closing movement of the vehicle panel in response to a user input force.

9. The actuating mechanism according to claim 8 wherein said spring and pulley assembly includes a first spring with a first spring end adapted to be fixed to a vehicle body member and a second spring end fixed to a first pulley that guides said drive cable and a second spring with a third spring end adapted to be fixed to the vehicle body member and a fourth spring end fixed to a second pulley that guides said drive cable.

10. The actuating mechanism according to claim 9 wherein said first and second pulleys are movable relative to the vehicle body member.

11. The actuating mechanism according to claim 9 including a third pulley and a fourth pulley that are each adapted to be fixed to the vehicle body member wherein said third pulley guides said drive cable into and out of said first pulley and said fourth pulley guides said drive cable into and out of said second pulley.

12. The actuating mechanism according to claim 11 wherein said first pulley moves toward said third pulley during normal closing movement of the vehicle panel by said motor and wherein said second pulley moves toward said fourth pulley during normal opening movement of the vehicle panel by said motor.

13. The actuating mechanism according to claim 12 wherein said second pulley moves toward said fourth pulley during a forced closing in response to the user input force and said first pulley moves toward said third pulley during a forced opening in response to the user input force.

14. The actuating mechanism according to claim 13 including a fifth pulley positioned between said first and second pulleys, said fifth pulley being coupled to said motor to drive said drive cable back and forth between said first and second pulleys.

15. The actuating mechanism according to claim 8 wherein the vehicle panel comprises a tailgate.
